(19) United States
(12) Patent Application Publication
(10) Pub. No.: US 2022/0293025 A1
(43) Pub. Date: Sep. 15, 2022

(54) ELECTRONIC DEVICE AND METHOD OF OPERATING THE SAME

(71) Applicant: SAMSUNG ELECTRONICS CO., LTD., Suwon-si (KR)

(72) Inventors: Jaesung Lee, Suwon-si (KR); Jongkon Bae, Suwon-si (KR); Minwoo Lee, Suwon-si (KR); Kyungtae Kim, Suwon-si (KR); Kwangtai Kim, Suwon-si (KR); Donghyun Yeom, Suwon-si (KR)

(21) Appl. No.: 17/658,791

(22) Filed: Apr. 11, 2022

Related U.S. Application Data
(63) Continuation of application No. PCT/KR2022/003274, filed on Mar. 8, 2022.

(30) Foreign Application Priority Data
Mar. 10, 2021 (KR) 10-2021-0031524

(51) Int. Cl. G09G 3/00; G09G 3/32

(52) U.S. Cl. CPC G09G 3/035; G09G 3/32; G09G 2300/0408; G09G 2320/0233; G09G 2310/08; G09G 2330/021

(57) ABSTRACT

An electronic device includes a display panel, a display driver IC (DDI), a gate driver, a light-emission driver, and a processor. The display panel includes multiple data lines, multiple gate signal lines, and light-emission signal lines. The DDI drives the display panel. The gate driver applies gate scan signals to the multiple gate signal lines, based on control of the DDI. The light-emission driver applies light-emission signals to the multiple light-emission signal lines, based on control of the DDI. The processor controls the DDI. The processor controls a first scan speed of the gate scan signals to be different from a second scan speed of the light-emission signals.

### CROSS-REFERENCE TO RELATED APPLICATIONS

This application is a bypass continuation of International Application No. PCT/KR2022/003274, filed on Mar. 8, 2022, and Korean Patent Application No. 10-2021-0031524, filed on Mar. 10, 2021, in the Korean Intellectual Property Office, the disclosures of which are incorporated by reference herein in their entirety.

### BACKGROUND

### 1. Field

Various embodiments of the disclosure relate to an electronic device and a method for operating the same.

### 2. Description of Related Art

Displays of electronic devices correspond to core technologies in the information communication era, and have been evolving to be thinner, lighter, portable, and high-performance. For example, OLED displays are drawing attention as flat display displays capable of reducing weight and volume, which are drawbacks of cathode ray tubes (CRTs). An OLED display may have multiple pixels disposed in a matrix type, thereby displaying images. Each of the pixels may include a light-emitting element, at least one thin film transistor (hereinafter, referred to as TFT) configured to independently drive the light-emitting element, and a storage capacitor.

### SUMMARY

When an image displayed on a foldable display or rollable display moves vertically, there may be a difference in speed of image update, depending on the position of gate lines. There is a problem in that such a difference in speed of image update, depending on the position of gate lines, results in a jelly-scroll effect (the image appears slanted). The speed of image update may be increased in an attempt to prevent the jelly-scroll effect of the display, but this causes a problem of increased power consumption due to high-speed driving, and increased component prices.

It is a technical aspect of various embodiments of the disclosure to provide an electronic device and a method for operating the same, wherein the occurrence of a jelly-scroll effect can be prevented in a foldable or rollable display.

Technical aspects to be accomplished by the disclosure are not limited to the above-mentioned technical aspects, and other technical aspects not mentioned herein will be clearly understood from the following description by those skilled in the art to which the disclosure pertains.

An electronic device according to various embodiments of the disclosure may include a display panel, a display driver IC (DDI), a gate driver, a light-emission driver, and a processor. The display panel may include multiple data lines, multiple gate signal lines, and light-emission signal lines. The DDI may drive the display panel. The gate driver may apply gate scan signals to the multiple gate signal lines, based on control of the DDI. The light-emission driver may apply light-emission signals to the multiple light-emission signal lines, based on control of the DDI. The processor may control the DDI. The processor may control a first scan speed of the gate scan signals to be different from a second scan speed of the light-emission signals.

In a method for operating an electronic device according to various embodiments of the disclosure, a gate driver may apply gate scan signals to multiple data lines disposed in a display panel at a first scan speed. A light-emission driver may apply light-emission signals to multiple light-emission signal lines disposed in the display panel at a second scan speed. A processor may control the first scan speed of the gate scan signals to be different from the second scan speed of the light-emission signals.

An electronic device according to various embodiments of the disclosure may prevent the occurrence of a jelly-scroll effect when an image moves vertically in a foldable or rollable display.

An electronic device according to various embodiments of the disclosure may prevent a jelly-scroll effect without increasing the DDI driving speed, thereby preventing power consumption and component prices from increasing.

Various other advantageous effects identified explicitly or implicitly through the disclosure may be provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an electronic device in a network environment according to various embodiments of the disclosure;

FIG. 2 is a block diagram of a display module according to various embodiments of the disclosure;

FIG. 3 illustrates the flat (e.g., opened) state of an electronic device according to various embodiments of the disclosure;

FIG. 4 illustrates the folded (e.g., closed) state of an electronic device according to various embodiments of the disclosure;

FIG. 5 is a block diagram of a display module according to an embodiment of the disclosure;

FIG. 6 illustrates a placement type of a display driver IC (DDI) in a foldable display;

FIG. 7 illustrates a jelly-scroll effect caused when an image displayed on a foldable display moves in the vertical direction;

FIG. 8 illustrates a display module according to an embodiment of the disclosure;

FIG. 9 illustrates a display module according to an embodiment of the disclosure;

FIG. 10 illustrates a method for operating an electronic device according to an embodiment of the disclosure;

FIG. 11 illustrates multiple gate scan signals and multiple light-emission signals applied to a display panel according to an embodiment of the disclosure; and

FIG. 12 illustrates a single gate scan operation and a multi-duty (or cycle) operation of a light-emission signal during a period of one frame according to an embodiment of the disclosure.

### DETAILED DESCRIPTION

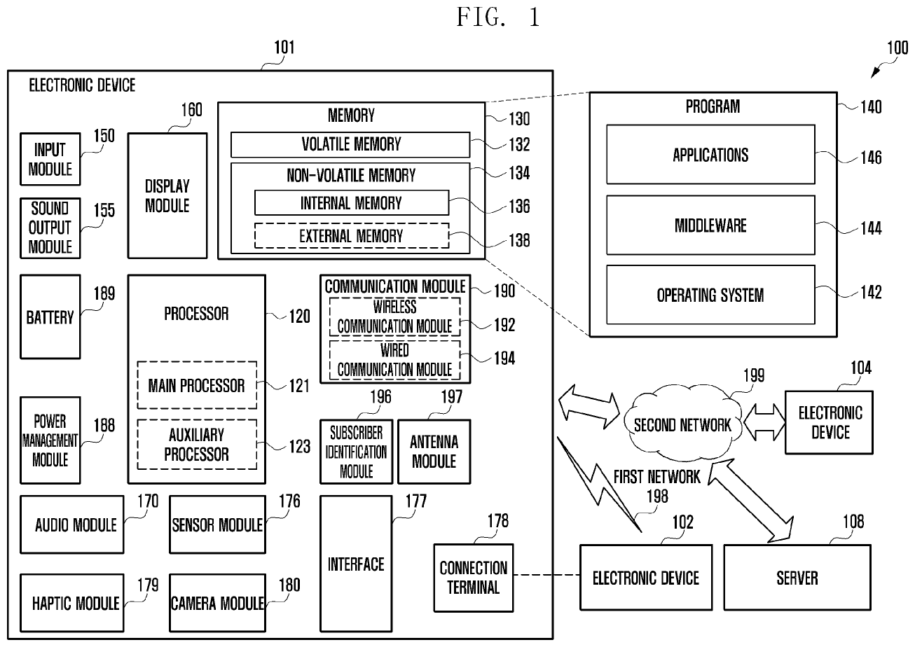

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, the display module 160 illustrated in FIG. 1 may include a flexible display configured to be able to be folded or unfolded.

According to an embodiment, the display module 160 illustrated in FIG. 1 may include a flexible display slidably disposed to provide a screen (e.g., a display screen).

For example, the display region of the electronic device 101 is a region visually exposed to allow an image to be output, and the electronic device 101 may adjust the display region on the basis of movement of a sliding plate (not shown) or movement of the display. There may be an example in which a rollable-type electronic device, which is configured to selectively enlarge a display region by at least partially operating at least a part (e.g., a housing) of the electronic device 101 in a slidable manner, includes the above-described display module 160. For example, the display module 160 may be called a slide-out display or an expandable display. According to an embodiment, the display module 160 illustrated in FIG. 1 includes a flexible display, but the disclosure is not limited thereto. The display module 160 may include a bar-type, or plate-type display.

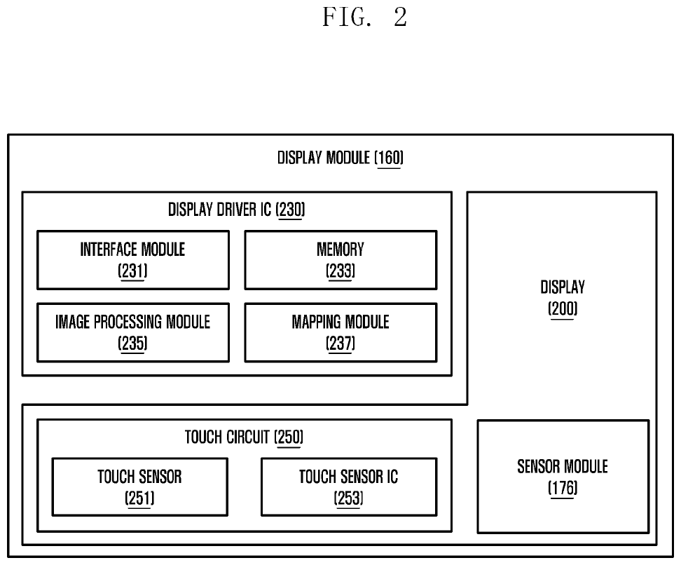

FIG. 2 is a block diagram of a display module according to various embodiments of the disclosure.

Referring to FIG. 2, a display module 160 may include a display 200, and a display driver IC 230 (hereinafter, referred to as DDI 230) for controlling the display 200.

The DDI 230 may include an interface module 231, a memory 233 (e.g., a buffer memory), an image processing module 235, and/or a mapping module 237.

According to an embodiment, the DDI 230 may receive image data, or image information including an image control signal corresponding to a command for controlling the image data from another element of the electronic device 101 through the interface module 231.

According to an embodiment, the image information may be received from a processor (e.g., the processor 120 in FIG. 1) (e.g., the main processor 121 in FIG. 1) (e.g., the application processor) or an auxiliary processor (e.g., the auxiliary processor 123 in FIG. 1) (e.g., the graphics processing unit) operated independently of functions of the main processor 121.

According to an embodiment, the DDI 230 may communicate with a touch circuit 250 or a sensor module 176 through the interface module 231. Further, the DDI 230 may store at least a part of the received image information to the memory 233. In an example, the DDI 230 may store at least a part of the received image information to the memory 233 in frame units.

According to an embodiment, the image processing module 235 may perform pre-processing or post-processing (e.g., perform resolution, brightness, or size adjustment) of at least a part of the image data, based at least on characteristics of the image data or characteristics of the display 200.

According to an embodiment, the mapping module 237 may generate a voltage value or a current value corresponding to the image data pre-processed or post-processed through the image processing module 235. In an embodiment, the generation of a voltage value or a current value may be performed based at least partially on, for example, attributes of pixels (e.g., arrangement of pixels (red-green-blue (RGB) stripe or Pentile structure) or the size of each of subpixels) of the display 200.

In an embodiment, at least some pixels of the display 200 may be driven based at least partially on the voltage value or the current value, and thus visual information (e.g., text, images, or icons) corresponding to the image data may be displayed through the display 200.

According to an embodiment, the display module 160 may further include a touch circuit 250. The touch circuit 250 may include a touch sensor 251 and a touch sensor IC 253 for controlling the same.

In an embodiment, the touch sensor IC 253 may control the touch sensor 251 in order to sense a touch input or a hovering input to a specific position on the display 200. For example, the touch sensor IC 253 may sense the touch input or the hovering input by measuring changes in a signal (e.g., a voltage, the amount of light, resistance, or the quantity of electric charge) regarding the specific position on the display 200. The touch sensor IC 253 may provide information (e.g., position, area, pressure, or time) about the sensed touch input or hovering input to the processor (e.g., the processor 120 in FIG. 1).

According to an embodiment, at least a part (e.g., the touch sensor IC 253) of the touch circuit 250 may be included as a part of the display driver IC 230 or a part of the display 200.

According to an embodiment, at least a part (e.g., the touch sensor IC 253) of the touch circuit 250 may be included as a part of another element (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176, or a control circuit therefor. The at least one sensor or the control circuit therefor may be embedded in a part (e.g., the display 200 or the DDI 230) of the display module 160 or in a part of the touch circuit 250. For example, when the sensor module 176 embedded in the display module 160 includes a biosensor (e.g., a fingerprint sensor), the biosensor may acquire, through a partial region of the display 200, biometric information (e.g., a fingerprint image) associated with a touch input. In another example, when the sensor module 176 embedded in the display module 160 includes a pressure sensor, the pressure sensor may acquire pressure information associated with a touch input through a partial region or the entire region of the display 200. According to an embodiment, the touch sensor 251 or the sensor module 176 may be disposed between pixels of a pixel layer of the display 200, or on or beneath the pixel layer.

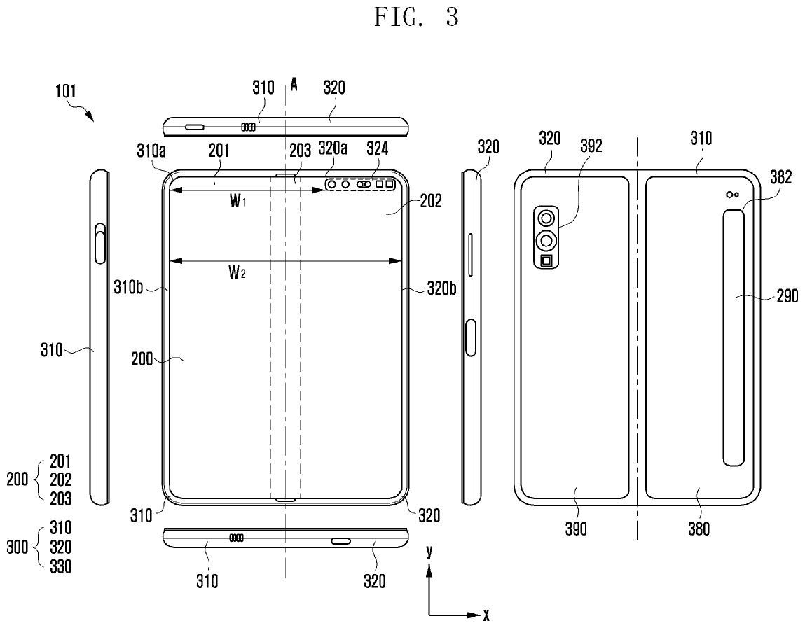

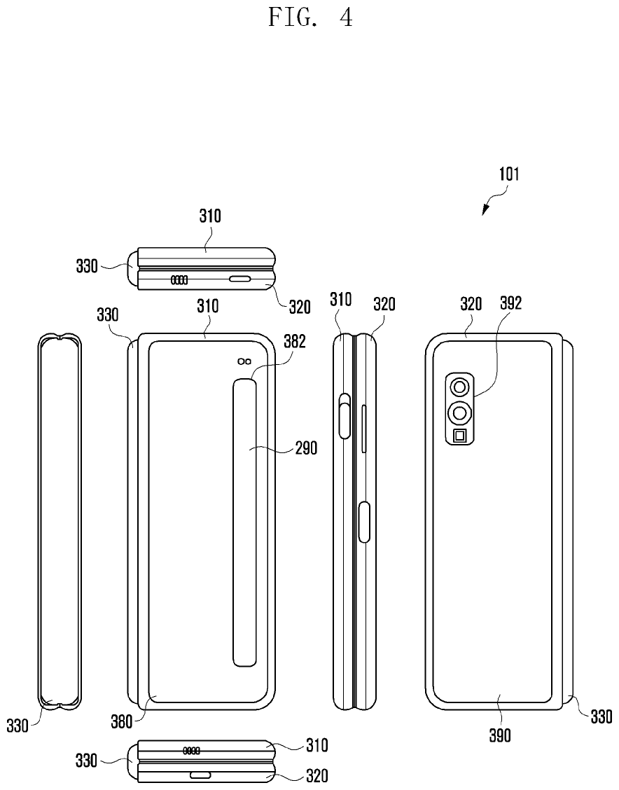

FIG. 3 illustrates the flat (e.g., opened) state of an electronic device according to various embodiments of the disclosure. FIG. 4 illustrates the folded (e.g., closed) state of an electronic device according to various embodiments of the disclosure.

Referring to FIGS. 3 and 4, an electronic device 101 may include a housing 300, a hinge cover 330 configured to cover a foldable part of the housing 300, and a display 200 disposed in a space formed by the housing 300. In an embodiment, the display 200 may be a flexible display or a foldable display.

A surface on which the display 200 is disposed may be defined as a first surface, or the front surface of the electronic device 101. Further, a surface opposite to the front surface may be defined as a second surface, or the rear surface of the electronic device 101. Further, a surface surrounding a space between the front surface and the rear surface may be defined as a third surface, or the side surface of the electronic device 101. For example, the electronic device 101 may be folded or unfolded in a first direction (e.g., the X-axis direction) with reference to a folding region 203.

In an embodiment, the housing 300 may include a first housing structure 310, a second housing structure 320 including a sensor region 324, a first rear cover 380, and a second rear cover 390. The housing 300 of the electronic device 101 is not limited to the type or the coupling, illustrated in FIGS. 3 and 4, and may be implemented by another shape or another combination and/or coupling of components. For example, in another embodiment, the first housing structure 310 and the first rear cover 380 may be integrally formed, and the second housing structure 320 and the second rear cover 390 may be integrally formed.

In the illustrated embodiment, the first housing structure 310 and the second housing structure 320 may be disposed at opposite sides about a folding axis A, and may have shapes which are overall symmetric with respect to the folding axis A. The angle or distance formed between the first housing structure 310 and the second housing structure 320 may vary depending on whether the electronic device 101 is in a flat state, is in a folded state, or is in an intermediate state. In the illustrated embodiment, the second housing structure 320, unlike the first housing structure 310, may additionally include the sensor region 324 in which various sensors are disposed, but may have a shape symmetric with that of the second housing structure 320 in other regions.

In an embodiment, the first housing structure 310 and the second housing structure 320 may form a recess for receiving the display 200 together. In the illustrated embodiment, due to the sensor region 324, the recess may have at least two different widths in a direction (e.g., the x-axis direction) perpendicular to the folding axis A.

For example, the recess may have a first width W1 between a first part 310a of the first housing structure 310 and a first part 320a of the second housing structure 320, formed at the edge of the sensor region 324 of the second housing structure 320. The recess may have a second width W2 formed between a second part 310b of the first housing structure 310, parallel to the folding axis A, in the first housing structure 310 and a second part 320b of the second housing structure 320, which is parallel to the folding axis A and does not correspond to the sensor region 324, in the second housing structure 320. The second width W2 may be formed to be larger than the first width W1. In other words, the first part 310a of the first housing structure 310 and the first part 320a of the second housing structure 320, which have asymmetrical shapes, may form the first width W1 of the recess. The second part 310b of the first housing structure 310 and the second part 320b of the second housing structure 320, which have symmetrical shapes, may form the second width W2 of the recess.

In an embodiment, the first part 320a and the second part 320b of the second housing structure 320 may have different distances from the folding axis A. The width of the recess is not limited to the illustrated example. In various embodiments, the recess may have multiple widths on the basis of the shape of the sensor region 324 or parts of the first housing structure 310 and the second housing structure 320, which have asymmetrical shapes.

In an embodiment, the first housing structure 310 and the second housing structure 320 may be at least partially formed of a metal or nonmetal material having rigidity, the magnitude of which is selected to support the display 200.

In an embodiment, the sensor region 324 may be formed to have a predetermined region adjacent to one corner of the second housing structure 320. However, the arrangement, shape, and size of the sensor region 324 are not limited to the illustrated example. For example, in another embodiment, the sensor region 324 may be provided at another corner of the second housing structure 320 or in a predetermined region between the top corner and the bottom corner. In an embodiment, components, embedded in the electronic device 101 so as to perform various functions, may be exposed on the front surface of the electronic device 101 through the sensor region 324 or through at least one opening provided in the sensor region 324. In various embodiments, the components may include various types of sensors. The sensors may include one or more of a front camera, a receiver, or a proximity sensor.

The first rear cover 380 may be disposed at one side of the folding axis A on the rear surface of the electronic device, and, for example, may have a substantially rectangular periphery. The periphery may be surrounded by the first housing structure 310. Similarly, the second rear cover 390 may be disposed at the other side of the folding axis A on the rear surface of the electronic device, and the periphery thereof may be surrounded by the second housing structure 320.

In the illustrated embodiment, the first rear cover 380 and the second rear cover 390 may have substantially symmetrical shapes with reference to the folding axis A. However, the first rear cover 380 and the second rear cover 390 do not necessarily have symmetrical shapes, and in another embodiment, the electronic device 101 may include the first rear cover 380 and the second rear cover 390, which have various shapes. In another embodiment, the first rear cover 380 may be formed integrally with the first housing structure 310, and the second rear cover 390 may be formed integrally with the second housing structure 320.

In an embodiment, the first rear cover 380, the second rear cover 390, the first housing structure 310, and the second housing structure 320 may form a space in which various components (e.g., a printed circuit board or a battery) of the electronic device 101 can be disposed. In an embodiment, one or more components may be disposed or visually exposed on the rear surface of the electronic device 101. For example, at least a part of a sub-display 290 may be visually exposed through a first rear region 382 of the first rear cover 380. In another embodiment one or more components or sensors may be visually exposed through a second rear region 392 of the second rear cover 390. In various embodiments, the sensors may include a proximity sensor and/or a rear camera.

The hinge cover 330 may be disposed between the first housing structure 310 and the second housing structure 320 and configured to cover internal components (for example, a hinge structure). In an embodiment, the hinge cover 330 may be covered or exposed outside by a part of each of the first housing structure 310 and the second housing structure 320, depending on the state (flat state or folded state) of the electronic device 101.

In an embodiment, as illustrated in FIG. 3, when the electronic device 101 is in a flat state, the hinge cover 330 may be covered by the first housing structure 310 and the second housing structure 320, and thus may not be exposed. In an embodiment, as illustrated in FIG. 4, when the electronic device 101 is in a folded state (e.g., a fully folded state), the hinge cover 330 may be exposed outside between the first housing structure 310 and the second housing structure 320. In an embodiment, in an intermediate state in which the first housing structure 310 and the second housing structure 320 are folded with a certain angle, the hinge cover 330 may be partially exposed outside between the first housing structure 310 and the second housing structure 320. However, in this case, an exposed region may be smaller than that in the fully folded state. In an embodiment, the hinge cover 330 may include a curved surface.

The display 200 may be disposed in a space formed by the housing 300. For example, the display 200 may be seated in a recess formed by the housing 300, and may form most of the front surface of the electronic device 101.

Therefore, the front surface of the electronic device 101 may include the display 200, and a partial region of the first housing structure 310 and a partial region of the second housing structure 320, which are adjacent to the display 200. Further, the rear surface of the electronic device 101 may include the first rear cover 380, a partial region of the first housing structure 310 adjacent to the first rear cover 380, the second rear cover 390, and a partial region of the second housing structure 320 adjacent to the second rear cover 390.

The display 200 may imply a display having at least a partial region which can be deformed into a flat surface or a curved surface. In an embodiment, the display 200 may include the folding region 203, and a first region 201, disposed at one side (at the left of the folding region 203 illustrated in FIG. 3), and a second region 202, disposed at the other side (the right side of the folding region 203 illustrated in FIG. 3), with reference to the folding region 203. The display 200 may include a polarizing film (or a polarizing layer), a window glass (e.g., ultra-thin glass (UTG) or a polymer window), and an optical compensation film (OCF).

The division of the region of the display 200 is for the illustrative purposes, and the display 200 may be divided into multiple (for example, at least four or two) regions depending on the structure or functions thereof. In an embodiment, the region of the display 200 may be divided by the folding region 203 or the folding axis A, which extends parallel to the y-axis. However, in another embodiment, the region of the display 200 may be divided with reference to another folding region (e.g., a folding region parallel to the x-axis) or another folding axis (e.g., a folding axis parallel to the x-axis).

The first region 201 and the second region 202 may have overall symmetrical shapes about the folding region 203. Unlike the first region 201, the second region 202 may include a cut notch due to the presence of the sensor region 324, but may have a shape symmetrical with that of the first region 201 in other regions. In other words, the first region 201 and the second region 202 may include parts having symmetrical shapes and parts having asymmetrical shapes.

Hereinafter, a description will be made of operations of the first housing structure 310 and the second housing structure 320 and each region of the display 200 according to the state (e.g., a flat state and a folded state) of the electronic device 101.

In an embodiment, when the electronic device 101 is in a flat state (e.g., FIG. 3), the first housing structure 310 and the second housing structure 320 may be placed to face an identical direction while forming an angle of 180 degrees therebetween. The surface of the first region 201 of the display 200 and the surface of the second region 202 may form 180 degrees therebetween, and may face an identical direction (e.g., toward the front surface of the electronic device). The folding region 203 may form an identical flat surface together with the first region 201 and the second region 202.

In an embodiment, when the electronic device 101 is in a folded state) (e.g., FIG. 4), the first housing structure 310 and the second housing structure 320 may be placed to face each other. The surface of the first region 201 of the display 200 and the surface of the second region 202 may face each other while forming a narrow angle (e.g., 0 to 10 degrees) therebetween. At least a part of the folding region 203 may be formed as a curved surface having a predetermined curvature.

In an embodiment, when the electronic device 101 is in an intermediate state (a half folded state), the first housing structure 310 and the second housing structure 320 may be placed to have a certain angle. The surface of the first region 201 of the display 200 and the surface of the second region 202 may form a larger angle than the folded state and a smaller angle than the flat state. The folding region 203 may be at least partially formed as a curved surface having a predetermined curvature. In this time, the curvature may be smaller than that in the folded state.

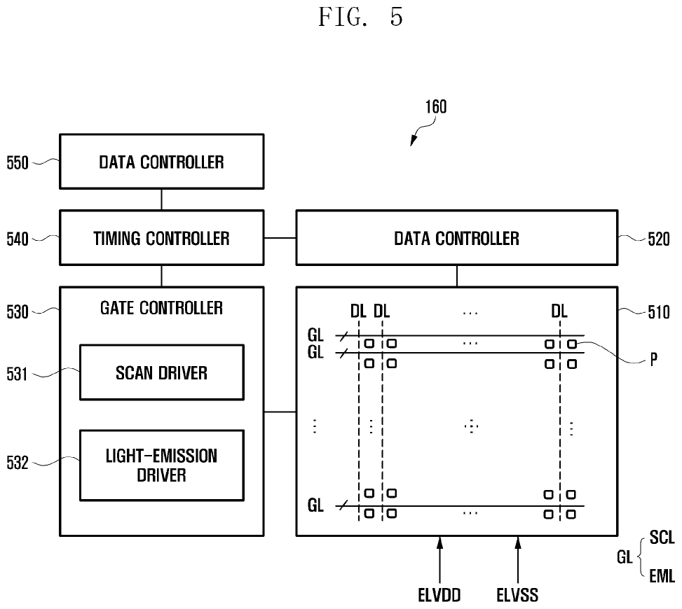

FIG. 5 is a block diagram of a display module according to an embodiment of the disclosure.

The display module 160 illustrated in FIG. 5 may be at least partially similar to the display module 160 illustrated in FIG. 1 and/or FIG. 2, or may include another embodiment.

Referring to FIG. 5, the display module 160 according to an embodiment may include a display panel 510, a data controller 520, a gate controller 530, a timing controller 540, and/or a memory 550 (e.g., dynamic random access memory (DRAM)).

According to various embodiments, at least some of the data controller 520, the gate controller 530, the timing controller 540, and/or the memory 550 (e.g., the dynamic random access memory (DRAM)) may be disposed in a DDI (e.g., the DDI 230 in FIG. 2).

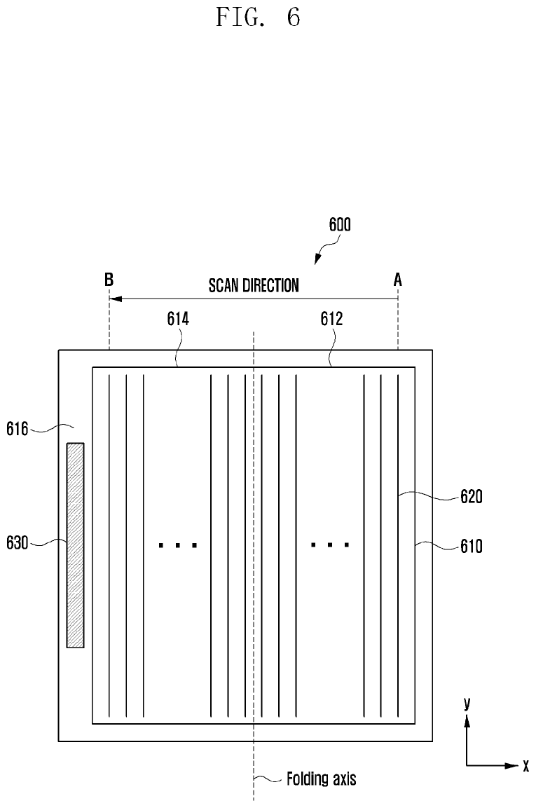

According to an embodiment, the data controller 520, the timing controller 540, and/or the memory 550 (e.g., the dynamic random access memory (DRAM)) may be disposed on the DDI 230 (e.g., the DDI 230 in FIG. 2), and the gate controller 530 may be disposed in a non-display region (e.g., a non-display region 616 in FIG. 6) of the display panel 510.

According to an embodiment, the display panel 510 may include multiple gate lines (GLs) and multiple data lines (DLs). According to an embodiment, the multiple gate lines (GLs) may be formed in a first direction (e.g., the transverse direction in FIG. 5), and may be disposed at a designated interval.

According to an embodiment, the multiple data lines (DLs) may be formed, for example, in a second direction (e.g., the longitudinal direction in FIG. 5) perpendicular to the first direction, and may be disposed at a designated interval.

In various embodiments of the disclosure, “the scan direction of the display panel 510” may be defined as a vertical direction (e.g., the transverse direction in FIG. 5) in which the gate lines (GLs) are formed. For example, when multiple gate lines (GLs) are formed in a first direction (e.g., the transverse direction in FIG. 5), the scan direction of the display panel 510 may be defined as a second direction (e.g., the longitudinal direction in FIG. 5) perpendicular to the first direction.

According to an embodiment, pixels (P) may be disposed in each of some regions of the display panel 510, in which the multiple gate lines (GLs) cross the multiple data lines (DLs). According to an embodiment, each pixel (P) may display a designated gradation by being electrically connected to a gate line (GL) and a data line (DL).

According to an embodiment, each pixel (P) may receive an input of a gate scan signal and a light-emission signal through a gate line (GL), and may receive an input of a data signal through a data line (DL). According to an embodiment, each pixel (P) may receive input of a high potential voltage (e.g., an ELVDD voltage) and a low potential voltage (e.g., an ELVSS voltage) as power for driving an organic light emitting diode (OLED).

According to an embodiment, each pixel (P) may include an OLED and a pixel driving circuit (not shown) for driving the OLED. According to various embodiments, the structure of each pixel (P) and the structure of the pixel driving circuit may be at least partially similar or identical to the structure of a pixel (P) and the pixel driving circuit, disclosed in Korean Registered Patent Publication No. 10-2189223.

According to an embodiment, the pixel driving circuit disposed in each pixel (P) may control, based on the gate scan signal and the light-emission signal, turning-on (an enabled state) or turning-off (e.g., a disabled state) of the OLED.

According to an embodiment, when being in a turned-on state (e.g., an enabled state), the OLED of each pixel (P) may display a gradation (e.g., luminance) corresponding to a data signal during a period of one frame.

According to an embodiment, the data controller 520 may drive multiple data lines (DLs). According to an embodiment, the data controller 520 may receive inputs of at least one synchronization signal and a data signal (e.g., digital image data) from the timing controller 540 or a processor 120 (e.g., the processor 120 in FIG. 1). According to an embodiment, the data controller 520 may determine a data voltage (e.g., analog image data) corresponding to the input data signal by using a reference gamma voltage and a designated gamma curve. According to an embodiment, the data controller 520 may apply the data voltage to the multiple data lines (DLs), thereby supplying the data voltage to each pixel (P).

According to an embodiment, the data controller 520 may receive inputs of multiple synchronization signals having an identical frequency or difference frequencies from the timing controller 540 or the processor 120 (e.g., the processor 120 in FIG. 1).

In an example, the data controller 520 may receive an input of a first synchronization signal having a first frequency (e.g., 30 Hz), a second synchronization signal having a second frequency (e.g., 60 Hz) higher than the first frequency, a third synchronization signal having a third frequency (e.g., 120 Hz) higher than the second frequency, or a fourth synchronization signal having a fourth frequency (e.g., 240 Hz) higher than the third frequency.

According to an embodiment, multiple synchronization signals may be frequency control signals generated by the processor 120 when the electronic device 101 drives a display (e.g., the display 200 in FIG. 2) through a split screen. For example, the processor 120 may execute a first application and a second application, and then may display an execution screen of the first application through a first part (e.g., the first region 201 in FIG. 3 or a first region 612 in FIG. 6) of the display panel 510 and may display an execution screen of the second application through a second part (e.g., the second region 202 in FIG. 3 or a second region 614 in FIG. 6) of the display panel 510.

According to an embodiment, the processor 120 may independently control a driving frequency of the execution screen of the first application, displayed through the first part (e.g., the first region 201 in FIG. 3 or the first region 612 in FIG. 6), and a driving frequency of the execution screen of the second application, displayed through the second part (e.g., the second region 202 in FIG. 3 or the second region 614 in FIG. 6).

According to an embodiment, in order to control the first part (e.g., the first region 201 in FIG. 3 or the first region 612 in FIG. 6) and the second part (e.g., the second region 202 in FIG. 3 or the second region 614 in FIG. 6) in a first driving frequency (e.g., 120 Hz), the processor 120 may supply a first synchronization signal corresponding to the first driving frequency to the data controller 520.

According to an embodiment, in order to control the first part (e.g., the first region 201 in FIG. 3 or the first region 612 in FIG. 6) in the first driving frequency (e.g., 120 Hz), the processor 120 may supply the first synchronization signal corresponding to the first driving frequency to the data controller 520, and, in order to control the second part (e.g., the second region 202 in FIG. 3 or the second region 614 in FIG. 6) in a second driving frequency (e.g., 60 Hz), may supply a second synchronization signal corresponding to the second driving frequency to the data controller 520.

According to an embodiment, the data controller 520 may apply a data voltage corresponding to the first driving frequency (e.g., 120 Hz) to some data lines (DLs) corresponding to the first part (e.g., the first region 201 in FIG. 3 or the first region 612 in FIG. 6) among the multiple data lines (DLs). In addition, the data controller 520 may apply a data voltage corresponding to the second driving frequency (e.g., 60 Hz) to some data lines (DLs) corresponding to the second part (e.g., the second region 202 in FIG. 3 or the second region 614 in FIG. 6) among the multiple data lines (DLs).

According to an embodiment, the gate controller 530 may drive the multiple gate lines (GLs). According to an embodiment, the gate controller 530 may receive an input of at least one synchronization signal from the timing controller 540 or the processor 120 (e.g., the processor 120 in FIG. 1).

According to an embodiment, the gate controller 530 may include a gate driver 531 (e.g., scan driver) for sequentially generating multiple gate scan signals on the basis of the synchronization signal and supplying the generated multiple gate scan signals to the gate lines (GLs).

According to an embodiment, the gate controller 530 may include a light-emission driver 532 for sequentially multiple light-emission signals on the basis of the synchronization signal and supplying the generated light-emission signals to the gate lines (GLs).

For example, each gate line (GL) may include a gate signal line (SCL), to which a gate scan signal is applied, and/or a light-emission signal line (EML), to which a light-emission signal is applied.

According to an embodiment, the gate controller 530 may receive synchronization signals that have an identical frequency and are input from the timing controller 540 or the processor 120 (e.g., the processor 120 in FIG. 1). In an embodiment, the gate controller 530 may apply a gate scan signal and/or a light-emission signal, corresponding to a first driving frequency (e.g., 120 Hz), to some gate lines (GLs) corresponding to the first part (e.g., the first region 201 in FIG. 3 or the first region 612 in FIG. 6) among the multiple gate lines (GLs), and may apply a gate scan signal and/or a light-emission signal, corresponding to the first driving frequency (e.g., 120 Hz), to some gate lines (GLs) corresponding to the second part (e.g., the second region 202 in FIG. 3 or the second region 614 in FIG. 6) among the multiple gate lines (GLs).

In another embodiment, the gate controller 530 may receive multiple synchronization signals which have different frequencies and are input from the timing controller 540 or the processor 120 (e.g., the processor 120 in FIG. 1). In an embodiment, the gate controller 530 may apply a gate scan signal and/or a light-emission signal, corresponding to a first driving frequency (e.g., 120 Hz), to some gate lines (GLs) corresponding to the first part (e.g., the first region 201 in FIG. 3 or the first region 612 in FIG. 6) among the multiple gate lines (GLs), and may apply a gate scan signal and/or a light-emission signal, corresponding to a second driving frequency (e.g., 60 Hz), to some gate lines (GLs) corresponding to the second part (e.g., the second region 202 in FIG. 3 or the second region 614 in FIG. 6) among the multiple gate lines (GLs).

According to an embodiment, the timing controller 540 may control driving timing of the gate controller 530 and the data controller 520. According to an embodiment, the timing controller 540 may acquire a data signal (e.g., digital image data) for one frame. According to an embodiment, the timing controller 540 may receive the data signal for one frame from the processor 120. According to an embodiment, the timing controller 540 may refer to the memory 550 (e.g., DRAM), which stores a data signal of a previous frame, so as to perform control such that at least a part of the display panel 510 displays an image of the previous frame, based on a designated event.

According to an embodiment, the timing controller 540 may convert the acquired data signal (e.g., the digital image data) so as to correspond to the resolution of the display panel 510, and may supply the converted data signal to the data controller 520.

FIG. 6 illustrates a placement type of a display driver IC (DDI) 630 in a foldable display 600.

Referring to FIG. 6, the foldable display 600 may include a display panel 610 and the DDI 630.

According to an embodiment, the display panel 610 may include a first region 612 and a second region 614. In an embodiment, the first region 612 and the second region 614 of the display panel 610 may be folded or unfolded in a first direction (e.g., the x-axis direction) with reference to a folding axis.

In an embodiment, the display panel 610 is folded with reference to the folding axis, and thus multiple gate lines 620 may be formed in a second direction (e.g., the y-axis direction).

According to an embodiment, the display panel 610 is folded with reference to the folding axis, and thus the DDI 630 may be disposed in a non-display region 616 of one side of the display panel 610 in the first direction (e.g., the x-axis direction). That is, the DDI 630 may be disposed in the non-display region 616 of a side parallel to the folding axis.

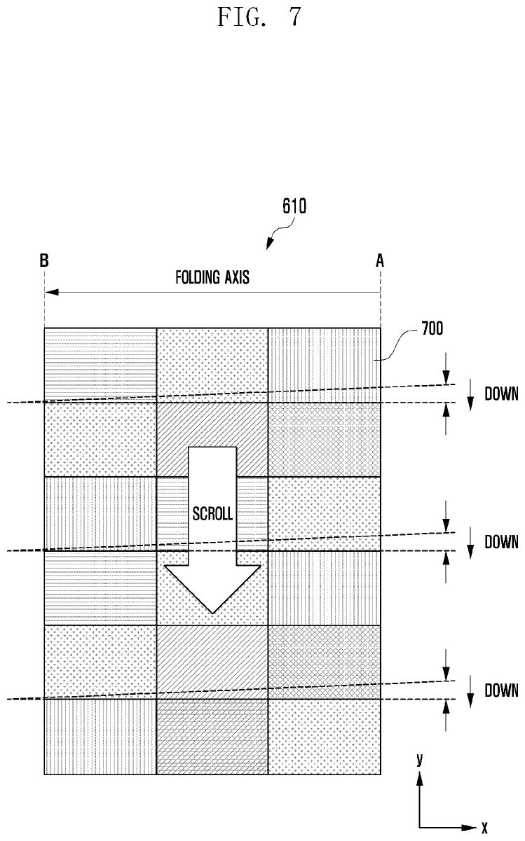

FIG. 7 illustrates a jelly-scroll effect caused when an image 700 displayed on a foldable display moves in the vertical direction.

Referring to FIG. 7, a gate scan may start from a gate line of a first part (A) and the scan may end in a gate line of a second part (B). When the image 700 is moved (e.g. scrolled) in the vertical direction in the display panel 610, a speed difference may be caused in updating of the image 700. That is, a speed difference may be caused, depending on the position of a gate line, in updating of the image 700 in each pixel.

The electronic device of the disclosure may maintain a gate scan speed as the gate scan speed is, when driving the display panel 610 and increase a light-emission scan (EM scan) speed, thereby preventing a jelly-scroll effect from being caused. The electronic device according to various embodiments of the disclosure may not increase the driving speed of the DDI, and may prevent a jelly-scroll effect to prevent an increase in power consumption and a rise in a component price.

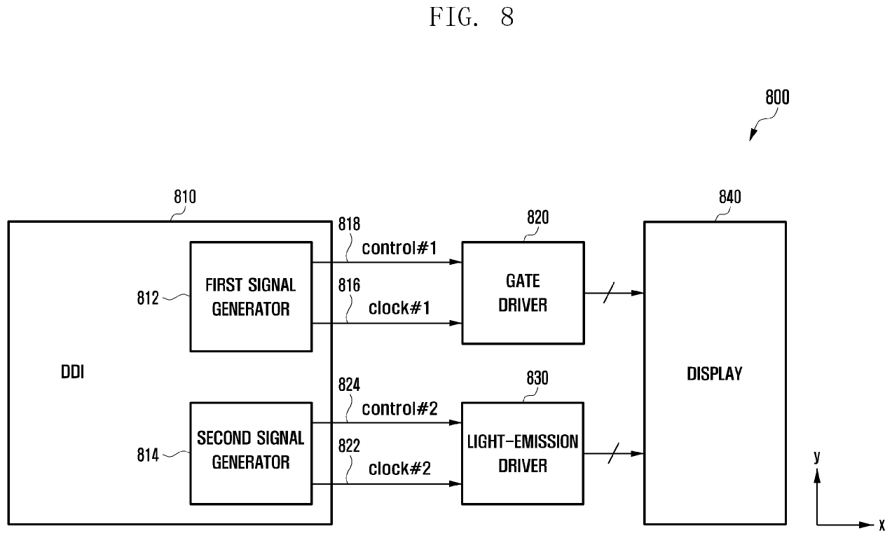

FIG. 8 illustrates a display module 800 according to an embodiment of the disclosure.

Referring to FIG. 8, the display module 800 according to an embodiment of the disclosure may include a DDI 810, a gate driver 820 (e.g., a scan driver), a light-emission driver 830, and a display 840.

The display 840 may include multiple gate lines (e.g., the multiple gate lines (GLs) in FIG. 5) and multiple data lines (e.g., the multiple data lines (DLs) in FIG. 5). According to an embodiment, the multiple gate lines (GLs) may be formed in a first direction (e.g., the x-axis direction), and may be disposed at a designated interval. According to an embodiment, the multiple data lines (DLs) may be formed, for example, in a second direction (e.g., the y-axis direction) perpendicular to the first direction, and may be disposed at a designated interval. According to an embodiment, each gate line (GL) may include gate signal lines (e.g., the gate signal lines (SCLs) in FIG. 5), to which a gate scan signal is applied, and/or light-emission signal lines (e.g., light-emission signal lines (EMLs) in FIG. 5), to which a light-emission signal is applied.

According to an embodiment, the DDI 810 may include a first signal generator 812 and a second signal generator 814. The first signal generator 812 may be electrically connected to the gate driver 820. The second signal generator 814 may be electrically connected to the light-emission driver 830.

In an embodiment, the first signal generator 812 may generate, based on a synchronization signal and a control signal input from a timing controller (e.g., the timing controller 540 in FIG. 5), first clocks 816 for driving the gate driver 820 and first control signals 818 for controlling the gate driver 820. The first clocks 816 and the first control signals 818, generated by the first signal generator 812, may be supplied to the gate driver 820.

In an embodiment, the second signal generator 814 may generate, based on a synchronization signal and a control signal input from a timing controller (e.g., the timing controller 540 in FIG. 5), second clocks 822 for driving the light-emission driver 830 and second control signals 824 for controlling the light-emission driver 830. The second clocks 822 and the second control signals 824, generated by the second signal generator 814, may be supplied to the light-emission driver 830.

In an embodiment, the gate signal lines (SCLs) may be electrically connected to the gate driver 820. The light-emission signal lines (EMLs) may be electrically connected to the light-emission driver 830.

In an embodiment, the gate driver 820 may generate multiple gate scan signals on the basis of the first clocks 816 and the first control signals 818, which are input from the first signal generator 812. The multiple gate scan signals generated by the gate driver 820 may be sequentially applied to the gate signal lines (SCLs) disposed in the display 840.

In an embodiment, the light-emission driver 830 may generate multiple light-emission signals on the basis of the second clocks 822 and the second control signals 824, which are input from the second signal generator 814. The multiple light-emission signals, generated by the light-emission driver 830, may be applied to the light-emission signal lines (EMLs) disposed in the display 840.

According to an embodiment, the multiple gate scan signals of the gate driver 820 and the multiple light-emission signals of the light-emission driver 830 may be generated to have an identical frequency.

According to an embodiment, a first scan speed of the multiple gate scan signals may be different from a second scan speed of the multiple light-emission signals.

In an embodiment, the multiple gate scan signals that are output from the gate driver 820 and applied to the display 840 may have a first scan speed.

In an embodiment, the multiple light-emission signals that are output from the light-emission driver 830 and applied to the display 840 may have a second scan speed higher than the first scan speed.

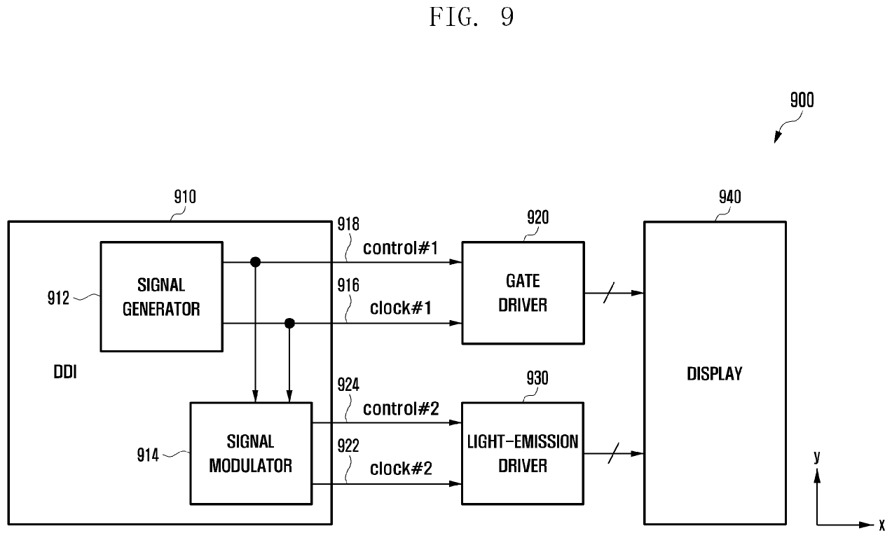

FIG. 9 illustrates a display module 900 according to an embodiment of the disclosure. In describing FIG. 9, a detailed description of the same elements as those of the display module 800 illustrated in FIG. 8 may be omitted.

Referring to FIG. 9, the display module 900 according to an embodiment of the disclosure may include a DDI 910, a gate driver 920, a light-emission driver 930, and a display 940.

The display 940 may include multiple gate lines (e.g., the multiple gate lines (GLs) in FIG. 5) and multiple data lines (e.g., the multiple data lines (DLs) in FIG. 5). According to an embodiment, each gate line (GL) may include gate signal lines (e.g., the gate signal lines (SCLs) in FIG. 5), to which a gate scan signal is applied, and/or light-emission signal lines (e.g., light-emission signal lines (EMLs) in FIG. 5), to which a light-emission signal is applied.

According to an embodiment, the DDI 910 may include a signal generator 912 and a signal modulator 914. In FIG. 9, the signal modulator 914 is disposed in the DDI 910. However, the signal modulator 914 may be disposed as a separate element outside the DDI 910.

In an embodiment, the signal generator 912 may be electrically connected to the gate driver 920. The signal modulator 914 may be electrically connected to the light-emission driver 930.

In an embodiment, the signal generator 912 may generate, based on a synchronization signal and a control signal input from a timing controller (e.g., the timing controller 540 in FIG. 5), first clocks 916 for driving the gate driver 920 and first control signals 918 for controlling the gate driver 920. The first clocks 916 and the first control signals 918, generated by the signal generator 912, may be supplied to the gate driver 920.

In an embodiment, the signal modulator 914 may receive the first clocks 916 and the first control signals 918, which are output from the signal generator 912.

The signal modulator 914 may modulate the received first clocks 916 and the received first control signals 918 to generate second clocks 922 for driving the light-emission driver 930 and second control signals 924 for controlling the light-emission driver 930. The second clocks 922 and the second control signals 924, generated by the signal modulator 914, may be supplied to the light-emission driver 930.

In an embodiment, the gate signal lines (SCLs) may be electrically connected to the gate driver 920. The light-emission signal lines (EMLs) may be electrically connected to the light-emission driver 930.

In an embodiment, the gate driver 920 may generate multiple gate scan signals on the basis of the first clocks 916 and the first control signals 918 that are input from the signal generator 912. The multiple gate scan signals that have been generated by the gate driver 920 may be sequentially applied to the gate signal lines (SCLs) disposed in the display 940.

In an embodiment, the light-emission driver 930 may generate multiple light-emission signals on the basis of the second clocks 922 and the second control signals 924 that are input from the signal modulator 914. The multiple light-emission signals that have been generated by the light-emission driver 930 may be applied to the light-emission signal lines (EMLs) disposed in the display 940.

According to an embodiment, the multiple gate scan signals of the gate driver 920 and the multiple light-emission signals of the light-emission driver 930 may be generated to have an identical frequency.

According to an embodiment, a first scan speed of the multiple gate scan signals may be different from a second scan speed of the multiple light-emission signals.

In an embodiment, the multiple gate scan signals that are output from the gate driver 920 and applied to the display 940 may have a first scan speed.

In an embodiment, the multiple light-emission signals that are output from the light-emission driver 930 and applied to the display 940 may have a second scan speed higher than the first scan speed.

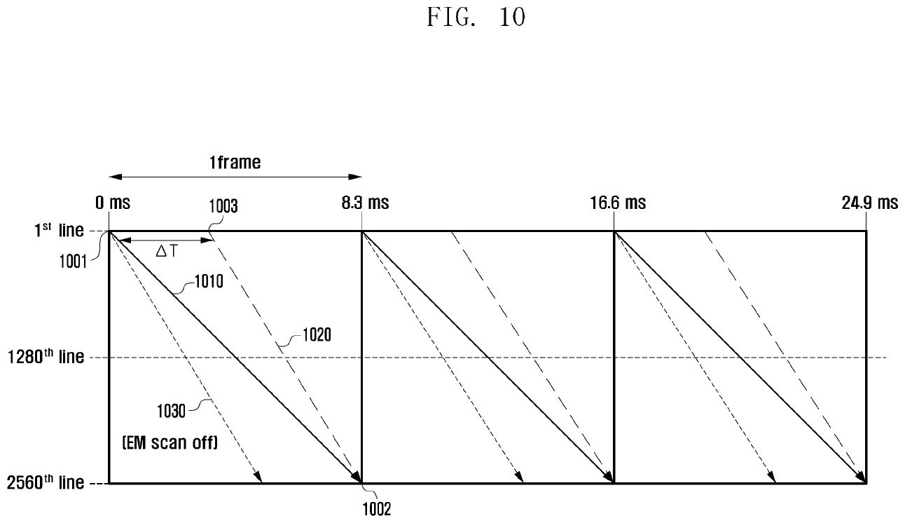

FIG. 10 illustrates a method for operating an electronic device according to an embodiment of the disclosure.

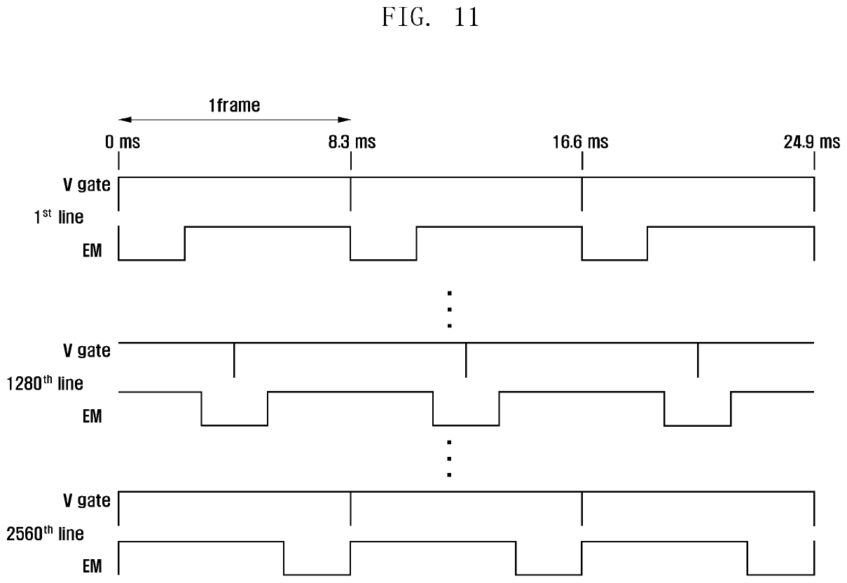

FIG. 11 illustrates multiple gate scan signals and multiple light-emission signals applied to a display panel according to an embodiment of the disclosure.

Referring to FIGS. 10 and 11, an electronic device (e.g., the electronic device 101 in FIG. 1 or the electronic device 101 in FIG. 3) according to an embodiment of the disclosure may drive a display panel (e.g., the display panel 610 in FIG. 6) in a first frequency (e.g., 120 Hz). When the display panel (e.g., the display panel 610 in FIG. 6) is driven in 120 Hz, a period of one frame may be about 8.3 ms.

The electronic device according to an embodiment of the disclosure may operate multiple gate scan signals 1010 at a first scan speed, and may operate multiple light-emission signals 1020 at a second scan speed higher than the first scan speed. Here, the multiple gate scan signals 1010 and the multiple light-emission signals 1020 may be generated as active-high signals.

According to an embodiment, a processor (e.g., the processor 120 in FIG. 1) may separately designate the number of pixels for calculating one horizontal period (1H) in the display module, such that the multiple gate scan signals 1010 and the multiple light-emission signals 1020 have different speeds.

In an embodiment, the processor (e.g., the processor 120 in FIG. 1) may separately designate the number of pixels for calculating one horizontal period (1H) by a gate driver (e.g., the gate driver 820 in FIG. 8 or the gate driver 920 in FIG. 9) and a light-emission driver (e.g., the light-emission driver 830 in FIG. 8 or the light-emission driver 930 in FIG. 9).

For example, the processor (e.g., the processor 120 in FIG. 1) may set the number of pixels for calculating one horizontal period (1H) by the gate driver (e.g., the gate driver 820 in FIG. 8 or the gate driver 920 in FIG. 9) to a first number. The processor (e.g., the processor 120 in FIG. 1) may set the number of pixels for calculating one horizontal period (1H) by the light-emission driver (e.g., the light-emission driver 830 in FIG. 8 or the light-emission driver 930 in FIG. 9) to a second number greater than the first number. When the number of pixels for calculating one horizontal period (1H) by the light-emission driver (e.g., the light-emission driver 830 in FIG. 8 or the light-emission driver 930 in FIG. 9) is set to the second number greater than the first number, the one horizontal period (1H) calculated by the light-emission driver (e.g., the light-emission driver 830 in FIG. 8 or the light-emission driver 930 in FIG. 9) may be shorter than the one horizontal period (1H) calculated by the gate driver (e.g., the gate driver 820 in FIG. 8 or the gate driver 920 in FIG. 9).

In an embodiment, the processor (e.g., the processor 120 in FIG. 1) may configure a frequency of a first clock, applied to the gate driver (e.g., the gate driver 820 in FIG. 8 or the gate driver 920 in FIG. 9), and a frequency of a second clock, applied to the light-emission driver (e.g., the light-emission driver 830 in FIG. 8 or the light-emission driver 930 in FIG. 9), to be different from each other.

In an embodiment, the processor (e.g., the processor 120 in FIG. 1) may apply a first clock having a first frequency to the gate driver (e.g., the gate driver 820 in FIG. 8 or the gate driver 920 in FIG. 9). The processor (e.g., the processor 120 in FIG. 1) may apply a second clock having a second frequency higher than the first frequency to the light-emission driver (e.g., the light-emission driver 830 in FIG. 8 or the light-emission driver 930 in FIG. 9).

In an embodiment, the first clock applied to the gate driver (e.g., the gate driver 820 in FIG. 8 or the gate driver 920 in FIG. 9) and the second clock applied to the light-emission driver (e.g., the light-emission driver 830 in FIG. 8 or the light-emission driver 930 in FIG. 9) may have different frequencies, and thus the speed of the multiple gate scan signals 1010 may be different from the speed of the multiple light-emission signals 1020.

In an embodiment, since the second frequency of the second clock is higher than the first frequency of the first clock, the speed of the multiple light-emission signals 1020 may be made to be higher than the speed of the multiple gate scan signals 1010. The multiple gate scan signals 1010 may be sequentially applied to multiple gate signal lines (e.g., the multiple gate signal lines (SCLs) in FIG. 5) at a first speed during a period of one frame. The multiple light-emission signals 1020 may be applied to multiple light-emission signal lines (e.g., the light-emission lines (EMSs) in FIG. 5) at a second speed higher (e.g., greater) than the first speed during the period of one frame.

In an embodiment, a light-emission scan may be started (e.g., at timing 1003) by supply of a first light-emission signal 1020 to a first light-emission signal line (EML) after a first time period (ΔT) elapses from a timing 1001 at which a gate scan is started by supply of a first gate scan signal 1010 to a first gate signal line (SCL). That is, a gate scan operation may be performed for the full time of one frame (e.g., a first time period). A light-emission scan operation may be performed for a time (e.g. a second time period) obtained by subtracting the first time period (ΔT) from the full time of one frame. Therefore, during the period of one frame, the time for the gate scan operation becomes longer than the time for the light-emission scan operation. That is, during the period of one frame, the time for the light-emission scan operation becomes shorter than the time for the gate scan operation. During the period of one frame, the longer the first time period (ΔT) is, the faster the speed of the light-emission scan may be.

In an embodiment, in the display panel (e.g., the display panel 610 in FIG. 6), the order of a light-emission signal off (EM scan off) operation, a gate scan operation, and a light-emission scan operation may be maintained without being changed.

In an embodiment, the light-emission signal off (EM scan off) operation and the light-emission scan operation may be performed by the same light-emission driver (e.g., the light-emission driver 830 in FIG. 8 or the light-emission driver 930 in FIG. 9), and thus a light-emission off signal 1030 and a light-emission signal 1020 may be scanned at the same speed.

In an example, a gate scan operation for all gate signal lines (SCLs) may be performed between a first timing 1001, at which scanning of the light-emission off signal 1030 is started, and a second timing 1002, at which scanning of the light-emission signals 1020 is ended, during a period of one frame.

According to an embodiment, the processor (e.g., the processor 120 in FIG. 1) may separate trigger signals that are applied to the gate driver (e.g., the gate driver 820 in FIG. 8 or the gate driver 920 in FIG. 9) and the light-emission driver (e.g., the light-emission driver 830 in FIG. 8 or the light-emission driver 930 in FIG. 9) so that a first start timing of the gate scan operation is different from a second start timing of the light-emission scan operation. That is, the processor (e.g., the processor 120 in FIG. 1) may separate trigger signal applied to the gate driver (e.g., the gate driver 820 in FIG. 8 or the gate driver 920 in FIG. 9) and the light-emission driver (e.g., the light-emission driver 830 in FIG. 8 or the light-emission driver 930 in FIG. 9) to adjust the first time period (ΔT) in the period of one frame. For example, the processor (e.g., the processor 120 in FIG. 1) may control a first trigger signal to be applied to the gate driver (e.g., the gate driver 820 in FIG. 8 or the gate driver 920 in FIG. 9) at a first timing. The processor (e.g., the processor 120 in FIG. 1) may control a second trigger signal to be applied to the light-emission driver (e.g., the light-emission driver 830 in FIG. 8 or the light-emission driver 930 in FIG. 9) after the first time period (ΔT) elapses from the first timing.

According to an embodiment, the processor (e.g., the processor 120 in FIG. 1) may control operations of a horizontal period (H) counter or a clock counter such that a first start timing of a gate scan operation by the gate driver (e.g., the gate driver 820 in FIG. 8 or the gate driver 920 in FIG. 9) is different from a second start timing of a light-emission scan operation by the light-emission driver (e.g., the light-emission driver 830 in FIG. 8 or the light-emission driver 930 in FIG. 9). That is, the processor (e.g., the processor 120 in FIG. 1) may control the operations of the horizontal period (H) counter or the clock counter to adjust the first time period (ΔT) in the period of one frame.

According to an embodiment, a light-emission signal 1020 is applied from a timing at which a data voltage is applied to each pixel of the display panel (e.g., the display panel 610 in FIG. 6), and thus times at which light-emission of the respective pixels actually starts may be different from each other.

In an embodiment, a brightness difference may be caused between respective (e.g., the display panel 610 in FIG. 6). The processor (e.g., the processor 120 in FIG. 1) may measure the brightness of each pixel through optical image-capturing, and may compensate for the brightness difference for each line (DL and GL 620), based on the measured brightness of each pixel.

In an embodiment, a brightness difference may be caused between respective lines of the display panel (e.g., the display panel 610 in FIG. 6). The processor (e.g., the processor 120 in FIG. 1) may generate compensation data according to the brightness difference between the respective lines, based on a light-emission time difference between the respective lines, and may supply the compensation data to the DDI to perform source voltage compensation. The processor may compensate for the brightness difference for each line (DL and GL 620) through the source voltage compensation.

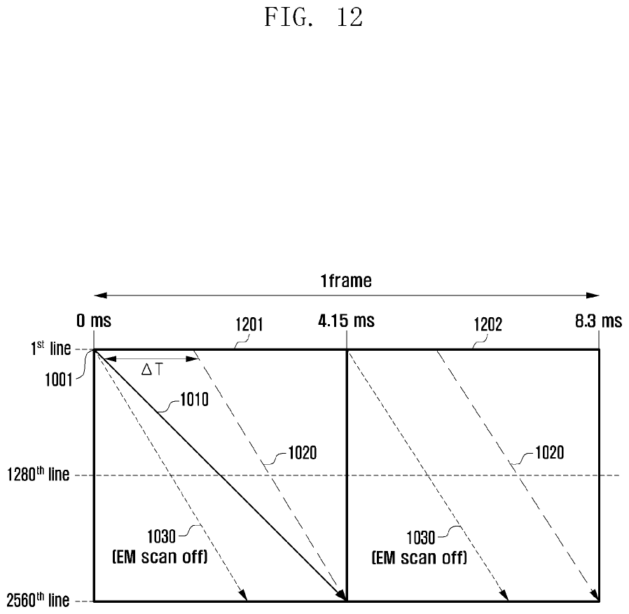

FIG. 12 illustrates a single gate scan operation and a multi-duty (or cycle) operation of a light-emission signal during a period of one frame according to an embodiment of the disclosure.

Referring to FIG. 12, according to various embodiments, an electronic device (e.g., the electronic device 101 in FIG. 1 or the electronic device 101 in FIG. 3) may configure multiple duties (or cycles) of a light-emission signal output in each frame.

According to an embodiment, the electronic device 101 may drive a display panel (e.g., the display panel 610 in FIG. 6) in 120 Hz 2 duty (or cycle). In this case, the period of one frame may be about 8.3 ms corresponding to 120 Hz, and the length of a duty which one light-emission signal has may be about 4.15 ms.

In an embodiment, during a first period 1201 of a period of a half of a frame (about 4.15 ms), a gate scan signal 1010 may be sequentially applied to all gate signal lines (SCLs), and a gate scan operation may be performed. In an embodiment, during the first period 1201 of the period of a half of a frame (about 4.15 ms), a first light-emission scan operation may be performed, and thus all pixels may perform first light emission. Subsequently, during a second period 1202, a light-emission signal off (EM scan off) operation may be performed, and second light-emission scan operation may be performed, and thus all pixels may perform second light emission.

As illustrated in FIG. 9, the electronic device 101 according to various embodiments may configure the number of duties (cycles) of a light-emission signal output during each frame as not only two but also four (e.g., four duties), six (e.g., six duties), or eight (e.g., eight duties).

When driving a display panel, the electronic device of the disclosure may maintain a gate scan speed as the gate scan speed is and increase a light-emission scan (EM scan) speed, thereby preventing a jelly-scroll effect from being caused. In various embodiments of the disclosure, the electronic device may not increase the driving speed of a DDI, and may prevent a jelly-scroll effect to prevent an increase of power consumption and a rise in component prices.

An electronic device (e.g., the electronic device 101 in FIG. 1 or the electronic device 101 in FIG. 3) according to various embodiments of the disclosure may include a display panel (e.g., the display panel 510 in FIG. 5 or the display panel 610 in FIG. 6), a display driver IC (DDI) (e.g., the DDI 230 in FIG. 2), a gate driver (e.g., the gate driver 531 in FIG. 5, the gate driver 820 in FIG. 8, or the gate driver 920 in FIG. 9), a light-emission driver (e.g., the light-emission driver 532 in FIG. 5, the light-emission driver 830 in FIG. 8, or the light-emission driver 930 in FIG. 9), and a processor (e.g., the processor 120 in FIG. 1). The display panel (e.g., the display panel 510 in FIG. 5 or the display panel 610 in FIG. 6) may include multiple data lines, multiple gate signal lines (e.g., the gate signal line (SCL) in FIG. 5), and multiple light-emission signal (e.g., the light-emission signal 1020 in FIG. 10) lines (e.g., the light-emission signal (e.g., the light-emission signal 1020 in FIG. 10) lines (EMLs) in FIG. 5). The DDI (e.g., the DDI 230 in FIG. 2) may drive the display panel (e.g., the display panel 510 in FIG. 5 or the display panel 610 in FIG. 6). The gate driver (e.g., the gate driver 531 in FIG. 5, the gate driver 820 in FIG. 8, or the gate driver 920 in FIG. 9) may apply, based on control of the DDI (e.g., the DDI 230 in FIG. 2), gate scan signals (e.g., the gate scan signals 1010 in FIG. 10) to the multiple gate signal lines (e.g., the gate signal lines (SCLs) in FIG. 5). The light-emission driver (e.g., the light-emission driver 532 in FIG. 5, the light-emission driver 830 in FIG. 8, or the light-emission driver 930 in FIG. 9) may apply, based on control of the DDI (e.g., the DDI 230 in FIG. 2), light-emission signals (e.g., the light-emission signals 1020 in FIG. 10) to the multiple light-emission signal (e.g., the light-emission signal 1020 in FIG. 10) lines (e.g., the light-emission signal (e.g., the light-emission signal 1020 in FIG. 10) lines (EMLs) in FIG. 5). The processor (e.g., the processor 120 in FIG. 1) may control the DDI (e.g., the DDI 230 in FIG. 2). The processor (e.g., the processor 120 in FIG. 1) may control a first scan speed of the gate scan signals (e.g., the gate scan signals 1010 in FIG. 10) to be different from a second scan speed of the light-emission signals (e.g., the light-emission signals 1020 in FIG. 10).

According to an embodiment, the processor (e.g., the processor 120 in FIG. 1) may make the second scan speed of the light-emission signals (e.g., the light-emission signals 1020 in FIG. 10) higher than the first scan speed of the gate scan signals (e.g., the gate scan signals 1010 in FIG. 10) during a period of one frame.

According to an embodiment, the processor (e.g., the processor 120 in FIG. 1) may supply a first light-emission signal (e.g., the light-emission signal 1020 in FIG. 10) to a first light-emission signal (e.g., the light-emission signal 1020 in FIG. 10) line (e.g., the light-emission signal (e.g., the light-emission signal 1020 in FIG. 10) line (EML) in FIG. 5) after a first time period elapses from a timing at which a first gate scan signal (e.g., the gate scan signal 1010 in FIG. 10) has been supplied to a first gate signal line (e.g., the gate signal line (SCL) in FIG. 5).

According to an embodiment, the processor (e.g., the processor 120 in FIG. 1) may make a second time period of a light-emission scan operation, at which the light-emission signals (e.g., the light-emission signals 1020 in FIG. 10) are supplied, shorter than a first time period of a gate scan operation, at which the gate scan signals (e.g., the gate scan signals 1010 in FIG. 10) are supplied, during a period of one frame.

According to an embodiment, the processor (e.g., the processor 120 in FIG. 1) may configure the number of pixels for calculating one horizontal period by the gate driver (e.g., the gate driver 531 in FIG. 5, the gate driver 820 in FIG. 8, or the gate driver 920 in FIG. 9) to be different from the number of pixels for calculating one horizontal period by the light-emission driver (e.g., the light-emission driver 532 in FIG. 5, the light-emission driver 830 in FIG. 8, or the light-emission driver 930 in FIG. 9).

According to an embodiment, the processor (e.g., the processor 120 in FIG. 1) may configure a frequency of a first clock applied to the gate driver (e.g., the gate driver 531 in FIG. 5, the gate driver 820 in FIG. 8, or the gate driver 920 in FIG. 9) to be different from a frequency of a second clock applied to the light-emission driver (e.g., the light-emission driver 532 in FIG. 5, the light-emission driver 830 in FIG. 8, or the light-emission driver 930 in FIG. 9).

According to an embodiment, the processor (e.g., the processor 120 in FIG. 1) may apply a first clock having a first frequency to the gate driver (e.g., the gate driver 531 in FIG. 5, the gate driver 820 in FIG. 8, or the gate driver 920 in FIG. 9), and may apply a second clock having a second frequency higher than the first frequency to the light-emission driver (e.g., the light-emission driver 532 in FIG. 5, the light-emission driver 830 in FIG. 8, or the light-emission driver 930 in FIG. 9).

According to an embodiment, the processor (e.g., the processor 120 in FIG. 1) may perform a gate scan operation for all gate signal lines (e.g., the gate signal line (SCL) in FIG. 5) between a first timing, at which scanning of a light-emission off signal is started, and a second timing, at which scanning of the light-emission signals (e.g., the light-emission signals 1020 in FIG. 10) is ended, during a period of one frame.

According to an embodiment, the processor (e.g., the processor 120 in FIG. 1) may apply a first trigger signal to the gate driver (e.g., the gate driver 531 in FIG. 5, the gate driver 820 in FIG. 8, or the gate driver 920 in FIG. 9) at a first timing. Further, the processor may apply a second trigger signal to the light-emission driver (e.g., the light-emission driver 532 in FIG. 5, the light-emission driver 830 in FIG. 8, or the light-emission driver 930 in FIG. 9) after the first time period elapses from the first timing.

According to an embodiment, the processor (e.g., the processor 120 in FIG. 1) may compensate, based on a difference in light-emission time of each line (DL and GL 620) of the display panel (e.g., the display panel 510 in FIG. 5 or the display panel 610 in FIG. 6), for a difference in luminance of each of the lines of the display panel.

In a method for operating an electronic device (e.g., the electronic device 101 in FIG. 1 or the electronic device 101 in FIG. 3) according to various embodiments of the disclosure, a gate driver (e.g., the gate driver 531 in FIG. 5, the gate driver 820 in FIG. 8, or the gate driver 920 in FIG. 9) may apply, at a first scan speed, gate scan signals (e.g., the gate scan signals 1010 in FIG. 10) to multiple data lines disposed in a display panel (e.g., the display panel 510 in FIG. 5 or the display panel 610 in FIG. 6). A light-emission driver (e.g., the light-emission driver 532 in FIG. 5, the light-emission driver 830 in FIG. 8, or the light-emission driver 930 in FIG. 9) may apply, at a second scan speed, light-emission signals (e.g., the light-emission signals 1020 in FIG. 10) to multiple light-emission signal (e.g., the light-emission signal 1020 in FIG. 10) lines (e.g., the light-emission signal (e.g., the light-emission signal 1020 in FIG. 10) lines (EMLs) in FIG. 5) disposed in the display panel (e.g., the display panel 510 in FIG. 5 or the display panel 610 in FIG. 6). A processor (e.g., the processor 120 in FIG. 1) may perform control such that the first scan speed of the gate scan signals (e.g., the gate scan signals 1010 in FIG. 10) is different from the second scan speed of the light-emission signals (e.g., the light-emission signals 1020 in FIG. 10).

According to an embodiment, the second scan speed of the light-emission signals (e.g., the light-emission signals 1020 in FIG. 10) may be made to be higher than the first scan speed of the gate scan signals (e.g., the gate scan signals 1010 in FIG. 10) during a period of one frame.

According to an embodiment, a first light-emission signal (e.g., the light-emission signal 1020 in FIG. 10) may be supplied to a first light-emission signal (e.g., the light-emission signal 1020 in FIG. 10) line (e.g., the light-emission signal (e.g., the light-emission signal 1020 in FIG. 10) line (EML) in FIG. 5) after a first time period elapses from a timing at which a first gate scan signal (e.g., the gate scan signal 1010 in FIG. 10) has been supplied to a first gate signal line (e.g., the gate signal line (SCL) in FIG. 5).

According to an embodiment, a second time period of a light-emission scan operation, at which the light-emission signals (e.g., the light-emission signals 1020 in FIG. 10) are supplied, may be made to be shorter than a first time period of a gate scan operation, at which the gate scan signals (e.g., the gate scan signals 1010 in FIG. 10) are supplied, during a period of one frame.

According to an embodiment, the number of pixels for calculating one horizontal period by the gate driver (e.g., the gate driver 531 in FIG. 5, the gate driver 820 in FIG. 8, or the gate driver 920 in FIG. 9) may be configured to be different from the number of pixels for calculating one horizontal period by the light-emission driver (e.g., the light-emission driver 532 in FIG. 5, the light-emission driver 830 in FIG. 8, or the light-emission driver 930 in FIG. 9).

According to an embodiment, a frequency of a first clock applied to the gate driver (e.g., the gate driver 531 in FIG. 5, the gate driver 820 in FIG. 8, or the gate driver 920 in FIG. 9) may be configured to be different from a frequency of a second clock applied to the light-emission driver (e.g., the light-emission driver 532 in FIG. 5, the light-emission driver 830 in FIG. 8, or the light-emission driver 930 in FIG. 9).

According to an embodiment, a first clock having a first frequency may be applied to the gate driver (e.g., the gate driver 531 in FIG. 5, the gate driver 820 in FIG. 8, or the gate driver 920 in FIG. 9), and a second clock having a second frequency higher than the first frequency may be applied to the light-emission driver (e.g., the light-emission driver 532 in FIG. 5, the light-emission driver 830 in FIG. 8, or the light-emission driver 930 in FIG. 9).

According to an embodiment, a gate scan operation for all gate signal lines (e.g., the gate signal lines (SCLs) in FIG. 5) may be performed between a first timing, at which scanning of a light-emission off signal is started, and a second timing, at which scanning of the light-emission signals (e.g., the light-emission signals 1020 in FIG. 10) is ended, during a period of one frame.

According to an embodiment, a first trigger signal may be applied to the gate driver (e.g., the gate driver 531 in FIG. 5, the gate driver 820 in FIG. 8, or the gate driver 920 in FIG. 9) at a first timing. Further, a second trigger signal may be applied to the light-emission driver (e.g., the light-emission driver 532 in FIG. 5, the light-emission driver 830 in FIG. 8, or the light-emission driver 930 in FIG. 9) after the first time period elapses from the first timing.

According to an embodiment, based on a difference in light-emission time of each line (DL and GL 620) of the display panel (e.g., the display panel 510 in FIG. 5 or the display panel 610 in FIG. 6), compensation may be made for a difference in luminance of each of the lines of the display panel.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a display panel comprising multiple data lines, multiple gate signal lines, and light-emission signal lines;
a display driver IC (DDI) configured to drive the display panel;
a gate driver configured to apply gate scan signals to the multiple gate signal lines, based on control of the DDI;
a light-emission driver configured to apply light-emission signals to the multiple light-emission signal lines, based on control of the DDI; and
a processor configured to control the DDI, and to control a first scan speed of the gate scan signals to be different from a second scan speed of the light-emission signals.

2. The electronic device of claim 1, wherein the processor is configured to control the second scan speed of the light-emission signals such that the second scan speed of the light-emission signals is greater than the first scan speed of the gate scan signals during a period of one frame.

3. The electronic device of claim 2, wherein the processor is configured to supply a first light-emission signal to a first light-emission signal line among the multiple light-emission signal lines after a first time period elapses from a timing at which a first gate scan signal is supplied to a first gate signal line.

4. The electronic device of claim 3, wherein the processor is configured to control a second time period of a light-emission scan operation, at which the light-emission signals are supplied, such that the second time period is shorter than a first time period of a gate scan operation, at which the gate scan signals are supplied, during a period of one frame.

5. The electronic device of claim 3, wherein the processor is configured to configure a number of pixels for calculating one horizontal period by the gate driver to be different from a number of pixels for calculating one horizontal period by the light-emission driver.

6. The electronic device of claim 5, wherein the processor is configured to configure a first frequency of a first clock applied to the gate driver to be different from a second frequency of a second clock applied to the light-emission driver.

7. The electronic device of claim 6, wherein the processor is configured to apply the first clock that generates the first frequency to the gate driver, and apply the second clock that generates the second frequency to the light-emission driver, wherein the second frequency is greater than the first frequency.

8. The electronic device of claim 3, wherein the processor is configured to perform a gate scan operation for the multiple gate signal lines between a first timing, at which scanning of a light-emission off signal starts, and a second timing, at which scanning of the light-emission signals ends, during a period of one frame.

9. The electronic device of claim 3, wherein the processor is configured to:
apply a first trigger signal to the gate driver at a first timing; and
apply a second trigger signal to the light-emission driver after the first time period elapses from the first timing.

10. The electronic device of claim 1, wherein the processor is configured to compensate, based on a difference in light-emission time of each line from among multiple gate lines and the multiple data lines of the display panel, for a difference in luminance of each of the lines from among the multiple gate lines and the multiple data lines of the display panel.

11. A method for operating an electronic device, the method comprising:
applying, by a gate driver, gate scan signals to multiple data lines disposed in a display panel at a first scan speed, and
applying, by a light-emission driver, light-emission signals to multiple light-emission signal lines disposed in the display panel at a second scan speed, and
controlling, by a processor, the first scan speed of the gate scan signals to be different from the second scan speed of the light-emission signals.

12. The method of claim 11, further comprising controlling, by the processor, the second scan speed of the light-emission signals such that the second scan speed of the light-emission signals is greater than the first scan speed of the gate scan signals during a period of one frame.

13. The method of claim 12, further comprising supplying, by the processor, a first light emission signal to a first light-emission signal line among the multiple light-emission signal lines after a first time period elapses from a timing at which a first gate scan signal is supplied to a first gate signal line.

14. The method of claim 13, further comprising, controlling, by the processor, a second time period of a light-emission scan operation, at which the light-emission signals are supplied, such that the second time period is shorter than a first time period of a gate scan operation, at which the gate scan signals are supplied, during a period of one frame.

15. The method of claim 13, further comprising configuring, by the processor, a number of pixels for calculating one horizontal period by the gate driver to be different from a number of pixels for calculating one horizontal period by the light-emission driver.

16. The method of claim 15, further comprising configuring by the processor, a first frequency of a first clock applied to the gate driver to be different from a second frequency of a second clock applied to the light-emission driver.

17. The method of claim 16, further comprising:
applying, by the processor, the first clock that generates the first frequency to the gate driver; and
applying, by the processor, the second clock that generates the second frequency to the light-emission driver,
wherein the second frequency is greater than the first frequency.

18. The method of claim 13, further comprising performing, by the processor, a gate scan operation for the multiple gate signal lines between a first timing, at which scanning of a light-emission off signal starts, and a second timing, at which scanning of the light-emission signals ends, during a period of one frame.

19. The method of claim 13, further comprising:
applying, by the processor, a first trigger signal to the gate driver at a first timing; and
applying a second trigger signal to the light-emission driver after the first time period elapses from the first timing.

20. The method of claim 11, further comprising compensating for a difference in luminance of each line from among multiple gate lines and the multiple data lines of the display panel, based on a difference in light-emission time of each of the lines from among the multiple gate lines and the multiple data lines of the display panel.
